(19) United States
(12) Patent Application Publication
(10) Pub. No.: US 2013/0087461 A1
(43) Pub. Date: Apr. 11, 2013

(54) CATALYST COATING AND PROCESS FOR PRODUCING IT

(71) Applicants: Jürgen Kintrup, Leverkusen (DE); Andreas Bulan, Langenfeld (DE); Vinh Trieu, Koln (DE); Harald Natter, Saarbrucken (DE); Rolf Hempelmann, St. Ingbert (DE)

(72) Inventors: Jürgen Kintrup, Leverkusen (DE); Andreas Bulan, Langenfeld (DE); Vinh Trieu, Koln (DE); Harald Natter, Saarbrucken (DE); Rolf Hempelmann, St. Ingbert (DE)

(73) Assignee: Bayer Intellectual Property GmbH, Monheim (DE)

(21) Appl. No.: 13/648,770

(22) Filed: Oct. 10, 2012

(30) Foreign Application Priority Data
Oct. 11, 2011 (DE) 10 2011 084 284.5

(51) Int. Cl. B01J 23/46; C25B 11/06; B01J 23/656; B01J 23/648; B01J 23/62; B01J 23/644

(52) U.S. Cl. 205/50; 502/325; 502/324; 502/5

(57) ABSTRACT

An improved catalyst coating comprising electrocatalytically active components based on ruthenium oxide and titanium oxide, especially for use in chloralkali electrolysis, is described. A production process for the catalyst coating and a novel electrode is also described.

### BACKGROUND OF THE INVENTION

The invention relates to an improved catalyst coating comprising electrocatalytically active components based on ruthenium oxide and titanium oxide, especially for use in chloralkali electrolysis for the preparation of chlorine. The invention further provides a production process for the catalyst coating and a novel electrode.

The present invention describes, in particular, a process for the electrochemical deposition of TiO₂—RuO₂ mixed oxide layers on a metallic support and also the use thereof as electrocatalysts in electrolysis to produce chlorine.

The invention proceeds from electrodes and electrode coatings which are known per se and usually comprise an electrically conductive support coated with a catalytically active component, in particular with a catalyst coating comprising electrocatalytically active components based on ruthenium oxide and titanium oxide.

Metal oxide coatings composed of titanium dioxide (TiO₂) and ruthenium dioxide (RuO₂) which are supported on titanium have long been known as stable electrocatalysts for electrolysis to produce chlorine.

These are conventionally produced by thermal decomposition of aqueous or organic ruthenium and titanium salt solutions which are applied to a titanium substrate by dipping, brushing on or spraying. Each application step is followed by a calcination. In general, a plurality of application/calcination steps are required to achieve the required catalyst loading on the electrode. This multistage process is very complicated and the plurality of calcination steps leads to deformation of the titanium substrate as a result of thermal expansion. The associated after-treatment which is therefore required can damage the adhesion of the coating to the support. The titanium substrate itself can form oxide layers as a result of the thermal treatment and these increase the ohmic resistance and thus also the overvoltage.

A further process for producing TiO₂—RuO₂ mixed oxide layers on a titanium support is the sol-gel synthesis. Here, an organic precursor solution is generally applied to the titanium.

In a similar way to the thermal decomposition process, the process requires a plurality of complicated calcination steps. The use of very expensive organic precursor salts is likewise a disadvantage of the sol-gel synthesis.

An alternative process which requires a smaller number of calcination steps is electrochemical deposition. In cathodic electroposition, metal ions are precipitated as amorphous oxides or hydroxides on the electrode from a solution by means of an electrogenerated base. Subsequent thermal treatment converts the amorphous precursors into crystalline oxides. Here, a distinction can be made between two different chemical routes: electrodeposition from corresponding peroxo complexes and electrodeposition from hydroxo complexes as precursors. Since these precursors are, unlike those in the two abovementioned processes, solid phases, a higher oxide loading on the electrode can be achieved in one deposition step, which reduces the number of calcination steps required.

Electrochemical deposition processes for producing pure TiO₂ layers and pure RuO₂ layers are already known.

US 2010290974 (A1) describes the cathodic deposition of TiO₂ from an electrolyte containing Ti(III) ions, nitrate and nitrite.

In Electrochimica Acta, 2009, 54, pages 4045-4055, P. M. Dziewonski and M. Grzeszczuk describe the electrochemical deposition of pure TiO₂ layers by means of cyclic voltammetry. The deposition is carried out from peroxo and oxalate complexes.

Anodic electrodeposition of pure TiO₂ layers and cathodic electrodeposition of pure RuO₂ layers are described by C. D. Lokhande, B.-O. Park, K.-D. Jung and O.-S. Joo in Ultramicroscopy, 2005, 105, pages 267-274.

The electrodeposition of pure RuO₂ layers from aqueous solution is also described in WO 2005050721 (A1) and by I. Zhitomirsky and L. Gal-Or in Material Letters, 1997, 31, pages 155-159.

The electrodeposition of pure RuO₂ layers by cyclic voltammetry is also known and is described by C.-C. Hu and K.-H. Chang in Journal of the Electrochemical Society, 1999, 146, pages 2465-2471. According to C.-C. Hu and K.-H. Chang, Electrochimica Acta, 2000, 45, pages 2685-2696, codeposition of iridium dioxide (IrO₂) is also possible by means of this process.

In CN101525760 (A), the electrodeposition of RuO₂ layers by pulse deposition is described.

Various electrochemical preparative routes are likewise known for the deposition of TiO₂—RuO₂ composite layers.

In Material Letters, 1998, 33, pages 305-310, I. Zhitomirsky describes the electrodeposition of TiO₂—RuO₂ composites by alternating electrodeposition of pure TiO₂ layers and pure RuO₂ layers.

In Journal of the Electrochemical Society, 2004, 151, pages C38-C44, S. Z. Chu, S. Inoue, K. Wada and S. Hishita describe the electrodeposition of TiO₂—RuO₂ composites by simultaneous deposition of the two components. According to these authors, the respective deposition mechanisms proceed independently of one another. TiO₂ is deposited from Ti-peroxo complexes as precursor. Ruthenium is deposited as metal and converted by subsequent calcination into RuO₂.

In Huaxue Xuebao, 2010, 68, pages 590-593, L. Zhang, J. Wang, H. Zhang and W. Cai describe TiO₂—RuO₂ composites which are obtained electrochemically by cathodic deposition of RuO₂ on spherical TiO₂ nanoparticles. The TiO₂ nanoparticles are applied beforehand to indium-tin oxide (ITO) by spin coating.

In Journal of Materials Science, 1999, 34, pages 2441-2447, I. Zhitomirsky describes for the first time simultaneous electrochemical deposition of TiO₂ and RuO₂, with the two components being deposited as mixed oxides. The same synthesis may also be found in further publications (I. Zhitomirsky, Journal of the European Ceramic Society, 1999, 19, pages 2581-2587 and I. Zhitomirsky, Advances in Colloid and Interface Science, 2002, 97, pages 279-317).

In this electrosynthesis, a bath consisting of methanol, water, ruthenium(III) chloride (RuCl₃), titanium(IV) chloride (TiCl₄) and hydrogen peroxide (H₂O₂) is used. TiO₂—RuO₂ layers are deposited successively as a multilayer at cathodic current densities of −20 mA/cm² (according to I. Zhitomirsky in Journal of Materials Science, 1999, 34, pages 2441-2447). The two metal components are, according to I. Zhitomirsky, deposited simultaneously via two different chemical routes: titanium via peroxo complexes and ruthenium via hydroxo complexes as precursor (described in Journal of Materials Science, 1999, 34, pages 2441-2447 and in Material Letters, 1998, 33, pages 305-310).

Deposition via different chemical routes can be a disadvantage for homogeneous mixing of the two components and thus also for mixed oxide formation. Although TiO₂ and RuO₂ are isomorphous, they cannot be bonded readily because of their different physical properties (TiO₂ as semiconductor and RuO₂ as metallic conductor). It is also known that the two oxides have a miscibility gap in the region of about 20-80 mol % of Ru and only metastable mixed oxides are formed in this region (described by K. T. Jacob and R. Subramanian in Journal of Phase Equilibra and Diffusion, 2008, 29, pages 136-140). In Material Letters, 1998, 33, pages 305-310, I. Zhitomirsky states that phase separation into a plurality of rutile phases occurs because the titanium and ruthenium components are precipitated at the electrode via different deposition mechanisms during the synthesis. The titanium component is precipitated via peroxo complexes as intermediate, while the ruthenium component is precipitated via hydroxo intermediates. Thus, the two deposition processes proceed independently of one another. Reworking of the synthesis described by Zhitomirsky (Journal of Materials Science, 1999, 34, pages 2441-2447) confirms these statements (see Example 1b).

However, good formation of a mixed oxide of TiO₂ and RuO₂ is known to be critical to anodic stability in electrolysis to produce chlorine. Pure RuO₂ is sensitive to corrosion by anodic oxygen evolution, which is associated with evolution of chlorine. Only the formation of a mixed oxide of RuO₂ and TiO₂ ensures satisfactory stability. The effect of mixed oxide formation on electrode stability is described by V. M. Jovanovic, A. Dekanski, P. Despotov, B. Z. Nikolic and R. T. Atanasoski in Journal of Electroanalytical Chemistry 1992, 339, pages 147-165.

It is an object of the present invention to provide an improved catalyst coating comprising electrocatalytically active components based on ruthenium oxide and titanium oxide which overcomes the above disadvantages of the coatings known hitherto and makes possible a lower overvoltage for the evolution of chlorine, for example in chloralkali electrolysis, when used on an electrode.

A specific object of the invention is to develop an electrochemical preparative process for TiO₂—RuO₂ mixed oxide layers which displays improved properties compared to the known processes.

A further object of the invention is to reduce the number of calcination steps required compared to the conventional synthetic route or other known processes. The process should be based on inexpensive starting materials composed of inorganic ruthenium and titanium salts which are likewise used in the conventional process. Compared to the conventional process and known electrochemical synthetic routes, it should display improved properties in respect of the catalytic activity, so that the noble metal content can be reduced.

### EMBODIMENTS OF THE INVENTION

An embodiment of the present invention is a catalyst coating comprising electrocatalytically active components based on ruthenium oxide and titanium oxide and optionally one or more metallic doping elements, wherein said ruthenium oxide and titanium oxide are predominantly present as RuO₂ and TiO₂ in rutile form, wherein said RuO₂ and TiO₂ are predominantly present as mixed oxide phase.

Another embodiment of the present invention is the above catalyst coating, wherein the one of more metallic doping elements are selected from the group consisting of iridium, tin, antimony, and manganese.

Another embodiment of the present invention is the above catalyst coating, wherein the ruthenium is present in an amount of from 10 to 21 mol %, based on the total amount of metals in the catalytically active component.

Another embodiment of the present invention is the above catalyst coating, wherein at least 75% by weight of the RuO₂ and TiO₂ is present as mixed oxide phase.

Yet another embodiment of the present invention is a process for electrochemically producing a catalyst coating comprising electrocatalytically active components based on ruthenium oxide and titanium oxide and optionally one or more metallic doping elements, comprising the step of applying the catalyst coating in a layer to an electrically conductive support material, wherein
a) the layer is applied to the support by means of an electrochemical process via the precipitation of Ru and Ti from an acidic aqueous solution containing at least Ru salts and titanium salts as hydroxo precursors, with the support being connected as cathode, and
b) the layer comprises hydroxo compounds and is subsequently subjected to thermal treatment at a temperature of at least 300° C. to form the catalyst coating.

Another embodiment of the present invention is the above process, wherein the support is based on metallic titanium or tantalum.

Another embodiment of the present invention is the above process, wherein the salt solution in step a) has a pH of not more than 3.5.

Another embodiment of the present invention is the above process, wherein the salt solution in step a) is kept acidic by means of dilute hydrochloric acid.

Another embodiment of the present invention is the above process, wherein a mixture of water with a lower alcohol is used as solvent for the salt solution in step a).

Another embodiment of the present invention is the above process, wherein a current density (absolute value) of at least 30 mA/cm² is maintained during the deposition in step a).

Another embodiment of the present invention is the above process, wherein the salt solution in step a) is maintained at a temperature of not more than 20° C.

Another embodiment of the present invention is the above process, wherein the precipitation of the hydroxo precursors of the metal oxides is effected by local base formation at the electrode surface.

Another embodiment of the present invention is the above process, wherein the heat treatment in step b) is carried out for at least 10 minutes.

Yet another embodiment of the present invention is an electrode comprising the above catalyst coating.

Another embodiment of the present invention is the above catalyst coating, wherein said mixed oxide phase is recognizable by a shift in the X-ray diffraction reflection at 27.477° (2 theta value of the pure TiO₂ rutile phase in the Cu Kₐₗₚₕₐ diffraction spectrum) to an angle of at least 27.54°.

Another embodiment of the present invention is the above catalyst coating, wherein the one of more metallic doping elements is iridium.

Another embodiment of the present invention is the above catalyst coating, wherein the one of more metallic doping elements is present in an amount of up to 20 mol %.

### DETAILED DESCRIPTION OF THE INVENTION

The above-described object is achieved according to the invention by use of a selected catalyst coating which is based on ruthenium oxide and titanium oxide and in which the RuO₂ and TiO₂ are predominantly present as mixed oxide phase.

The invention provides a catalyst coating comprising electrocatalytically active components based on ruthenium oxide and titanium oxide and optionally one or more metallic doping elements, in particular from the series of the transition metals, where the components ruthenium oxide and titanium oxide are predominantly present as RuO₂ and TiO₂ in rutile form, characterized in that RuO₂ and TiO₂ are predominantly present as mixed oxide phase, in particular recognizable by a shift in the X-ray diffraction reflection at 27.477° (2 theta value of the pure TiO₂ rutile phase in the Cu Kₐₗₚₕₐ diffraction spectrum) to an angle of at least 27.54°.

It has surprisingly been found that titanium can also be deposited electrochemically as hydroxo complex. Titanium and ruthenium can thus both be deposited via the same chemical route, which improves the homogeneity of mixing of the two components. This altered deposition mechanism also changes the growth mechanism of the layers and a particular surface morphology is obtained.

Preference is given to at least 75% by weight of the RuO₂ and TiO₂ being present as mixed oxide phase in the catalyst coating.

The mixed oxides prepared according to the invention are characterized in that they display a different layer growth compared to the other processes and therefore form a specific surface morphology in which a mud-cracked structure which has very wide cracks and additionally has spherical structures on the surface is formed.

This particular surface morphology obviously increases the active surface area which can be utilized for electrocatalysis. The catalytic activity is thus improved and the noble metal content can be reduced.

In the case of electrochemically prepared TiO₂—RuO₂ mixed oxides, mud-cracked surfaces having islands about 10-20 μm wide and cracks of about 5-10 μm are, for example, obtained (FIGS. 1a and b). Spherical structures having a diameter of about 0.1-2 μm are present on the surface of the islands (FIGS. 1a and b). The conventionally prepared TiO₂—RuO₂ comparative specimen displays islands about 5-10 μm wide and a narrower crack width of about 1 μm (FIGS. 2a+b).

This particular surface morphology having the spherical structures is not achieved by other preparation methods such as thermal decomposition or the sol-gel synthesis. The electrochemical mixed oxide synthesis for TiO₂—RuO₂ of I. Zhitomirsky, described in Journal of Materials Science, 1999, 34, pages 2441-2447, which is presented below as comparative example, also displays a smooth surface morphology without spherical structures.

Noble metals generally display spherical growth (cauliflower structure) when they are produced in nanocrystalline form by electrodeposition. Spherical structures have already been reported (C.-C. Hu and K.-H. Chang in Electrochimica Acta 2000, 45, pages 2685-2696) for noble metal oxide layers such as amorphous RuO₂—IrO₂ layers which have been produced by cyclic voltammetry. RuO₂ and IrO₂ very readily form mixed oxides since they are isomorphous and have very similar lattice constants. In addition, both are metallic conductors. This type of growth has not yet been reported for the semiconductor TiO₂ or for mixed oxides containing TiO₂. The examples presented here (cf. FIGS. 1 and 9 to 14) display spherical growth at a TiO₂ content of 70-82 mol %.

The invention further provides a process for the electrochemical production of a catalyst coating comprising electrocatalytically active components based on ruthenium oxide and titanium oxide and optionally one or more metallic doping elements, in particular from the series of the transition metals, where the catalyst coating is applied to an electrically conductive support material, characterized in that
a) the layer is applied to the support by means of an electrochemical process via the precipitation of Ru and Ti from an acidic aqueous solution containing at least Ru salts and titanium salts as hydroxo precursors, with the support being connected as cathode,
b) the layer containing hydroxo compounds which is formed is subsequently subjected to thermal treatment at a temperature of at least 300° C., preferably at least 400° C., to form the catalyst coating.

The mixed oxides can be produced by means of only one calcination step, so that complicated multistage processes like those known from the prior art can be avoided.

It is also possible, in particular, for metal substrates having a complex geometry, e.g. expanded metals, to be coated.

A preferred process is characterized in that the support is based on metallic titanium or tantalum, preferably on titanium.

As preferred ruthenium and titanium salts, ruthenium chloride and titanium chloride are used in step a).

To produce a catalyst coating comprising binary TiO₂—RuO₂ mixed oxides, titanium(IV) chloride (TiCl₄), ruthenium(III) chloride (RuCl₃), sodium chloride (NaCl), hydrochloric acid (HCl), isopropanol (i-PrOH) and water H₂O are used as starting materials in a particularly preferred process.

The difficulty in the electrochemical synthesis of metal oxide is that the oxide should be precipitated only on the electrode and not in the electrolyte. Otherwise, the deposition bath is unstable. In addition, the pure noble metal can be deposited cathodically as a secondary reaction. These problems can, in particular, be solved by means of a specific bath composition, the deposition temperature, the deposition current parameters and optionally the flow conditions.

In a preferred process, the salt solution in step a) has a pH of not more than 3.5.

The salt solution in step a) is particularly preferably kept acidic by means of dilute hydrochloric acid.

As particularly preferred solvent for the salt solution in step a), use is made of a mixture of water with a lower alcohol (C₁-C₄-alcohol), in particular with isopropanol.

In a further preferred variant of the novel process, a current density (absolute value) of at least 30 mA/cm² is maintained during the deposition in step a).

Another preferred variant of the novel process is characterized in that the salt solution in step a) is maintained at a temperature of not more than 20° C., preferably not more than 10° C., particularly preferably not more than 5° C.

In a particularly preferred embodiment of the novel process, the precipitation of the hydroxo precursors of the metal oxides is effected by local base formation at the electrode surface.

The heat treatment in step b) of the novel process is particularly preferably carried out for at least 10 minutes.

As a result of the relatively high concentration of titanium salt and ruthenium salt, the two components are deposited unselectively and can better form a homogenous mixed oxide. Since no peroxide is present in the deposition bath, both components are deposited via hydroxo complexes. Deposition via a common chemical route obviously promotes mixed oxide formation.

The stability of the deposition bath is particularly preferably ensured by acidification with hydrochloric acid (HCl) and a low reaction temperature of 5° C. To ensure the stability, it is desirable for the overall pH of the bath to remain constant. The electrolyte volume in the deposition should therefore, in particular, be selected so that the local pH changes are compensated or appropriate further amounts of HCl have to be introduced.

Multinary mixed oxides can preferably also be obtained by the alternative addition of further metal salts as dopants, e.g. iridium(III) chloride (IrCl₃), tin(IV) chloride (SbCl₃), antimony(III) chloride (SbCl₃) and manganese(II) chloride (MnCl₂), to the solution in step a) of the novel process. The stoichiometry of the mixed oxides obtained depends on the electrolyte composition and the current density and can thus be controlled. Examples of electrochemical synthetic routes to ternary and multinary mixed oxides based on TiO₂—RuO₂ have hitherto not been published.

The invention also provides a novel electrode having a novel catalyst coating as described above.

Preference is given to an electrode having a novel catalyst coating which has been obtained from a novel process as described above.

The invention further provides for the use of the novel electrode for the electrochemical preparation of chlorine from hydrogen chloride solutions or alkali metal chloride solutions, in particular from sodium chloride solutions.

### BRIEF DESCRIPTION OF THE DRAWINGS

The invention is illustrated below with the aid of the figures and the examples, but these do not constitute a restriction of the invention.

The figures show:

FIGS. 1a+b scanning electron micrographs of a TiO₂—RuO₂/Ti coating containing 18 mol % of Ru formed by electrodeposition at different enlargements

FIGS. 2a+b scanning electron micrographs of a comparative sample: TiO₂—RuO₂/Ti containing 31.5 mol % of Ru (from Example 1c) formed by the thermal decomposition process at different enlargements

FIG. 3 X-ray diffraction pattern of a TiO₂—RuO₂/Ti coating containing 18 mol % of Ru formed by electrodeposition. The X-ray diffraction pattern is baseline-corrected and corrected on the 20 axis in accordance with the (002) reflection of titanium as internal reference

| | | | 2θ reference |
|---|---|---|---|
| 2θ reflection/° | Assignment | (hkl) | value/° |
| 27.60 (±0.06) | TiO₂—RuO₂ rutile mixed | (110) | |
| | oxide phase | | |
| | TiO₂ rutile 00-021-1276 | (110) | 27.477 |
| | RuO₂ rutile 00-040-1290 | (110) | 28.010 |

FIGS. 4a+b scanning electron micrographs of the Zhitomirsky comparative sample (as per Example 1b) at different enlargements

FIG. 5 X-ray diffraction pattern of TiO₂—RuO₂ obtained by the literature method of Zhitomirsky using a 25% Ru bath composition:

| | | | 2θ reference |
|---|---|---|---|
| 2θ reflection/° | Assignment | (hkl) | value/° |
| 27.48 (±0.06) | TiO₂—RuO₂ rutile mixed | (110) | |
| | oxide phase | | |
| | TiO₂ rutile, powder | (110) | 27.477 |
| | diffraction file number | | |
| | 00-021-1276 | | |
| | RuO₂ rutile, powder | (110) | 28.010 |
| | diffraction file number | | |
| | 00-040-1290 | | |

FIG. 6 X-ray diffraction pattern of TiO₂—RuO₂ obtained by a modification of the literature method of Zhitomirsky using a 40% Ru bath composition:

| | | | 2θ reference |
|---|---|---|---|
| 2θ reflection/° | Assignment | (hkl) | value/° |
| 27.48 (±0.08) | TiO₂—RuO₂ rutile mixed | (110) | |
| | oxide phase | | |
| | TiO₂ rutile, powder | (110) | 27.477 |
| | diffraction file number | | |
| | 00-021-1276 | | |
| | RuO₂ rutile, powder | (110) | 28.010 |
| | diffraction file number | | |
| | 00-040-1290 | | |

FIG. 7 X-ray diffraction pattern of TiO₂—RuO₂ obtained by a modification of the literature method of Zhitomirsky using a 53% Ru bath composition:

| | | | 2θ reference |
|---|---|---|---|
| 2θ reflection/° | Assignment | (hkl) | value/° |
| 27.5 (±0.08) | TiO₂—RuO₂ rutile mixed | (110) | |
| | oxide phase | | |
| | TiO₂ rutile, powder | (110) | 27.477 |
| | diffraction file number | | |
| | 00-021-1276 | | |
| | RuO₂ rutile, powder | (110) | 28.010 |
| | diffraction file number | | |
| | 00-040-1290 | | |

FIGS. 8a+b scanning electron micrographs of a TiO₂—RuO₂—IrO₂/Ti coating containing 16 mol % of Ru and 2.6 mol % of Ir formed by electrodeposition at different enlargements

FIGS. 9a+b scanning electron micrographs of a comparative sample: TiO₂—RuO₂—IrO₂/Ti coating containing 17 mol % of Ru and 8.7 mol % of Ir formed by thermal decomposition process (see Example 1d) at different enlargements

FIGS. 10a+b scanning electron micrographs of a TiO₂—RuO₂—SnO₂/Ti coating containing 16.2 mol % of Ru and 11 mol % of Sn formed by electrodeposition at different enlargements

FIG. 11 a scanning electron micrograph of a TiO₂—RuO₂—SbO₂/Ti coating containing 14 mol % of Ru and 6 mol % of Sb formed by electrodeposition

FIG. 12 a scanning electron micrograph of a TiO₂—RuO₂—MnO₂/Ti coating containing 15 mol % of Ru and 6 mol % of Mn formed by electrodeposition

FIG. 13 a scanning electron micrograph of a TiO₂—RuO₂—SnO₂—SbO₂/Ti coating containing 11.5 mol % of Ru, 9.5 mol % of Sn, 5.5 mol % of Sb formed by electrodeposition

A diffractometer model X′Pert Pro MP from PANalytical B.V. was used for measuring the X-ray diffraction patterns in the following examples. The diffractometer operates using Cu Kₐₗₚₕₐ X-radiation. Control of the instrument and recording of the data generated is carried out by means of the X′Pert Data Collector software. Measurements were carried out using a scanning speed of 0.0445°/s and a step size of 0.0263°.

The diffraction patterns shown in the examples were corrected for background. In addition, a high error correction based on the (002) reference peak of the titanium substrate as internal reference was carried out.

The scanning electron microscopy (SEM) studies were carried out on a JEOL model JxA-840A instrument.

Electrochemical experiments were carried out on a 16-fold multichannel potentiostat/galvanostat (model VMP3) from Princeton Applied Research/BioLogic Science Instruments. The experiments were carried out under computer control using the EC-Lab software. Measured potentials were corrected for ohmic voltage drops in the cell (known as IR correction).

The present measurements by means of optical emission spectral analysis using inductively coupled plasma (ICP-OES) were carried out using a model 720-ES spectrometer from Varian. For the sample preparation, the electrocoating was detached from the substrate and the resulting suspension was dissolved by addition of aqua regia and heating.

### EXAMPLES

### Example 1a

The titanium electrode in the form of a plate having a diameter of 15 mm and a thickness of 2 mm is pretreated by sand blasting and chemical pickling (at 80° C. in 10% strength by weight oxalic acid for 2 hours).

The deposition bath contains isopropanol (i-PrOH) and water in a volume ratio of 9:5, 63 millimol/litre of titanium(IV) chloride (63 mM/1 of TiCl₄), 15 millimol/litre of ruthenium(III) chloride (15 mM/1 of RuCl₃), 20 millimol/litre of hydrochloric acid (20 mM/1 of HCl) and 12 millimol/litre of sodium chloride (12 mM/1 of NaCl).

(The alcohol/water ratio indicated in the example is the final ratio which is to be obtained after addition of all salts and acids.) Electrodeposition is carried out in a 3-electrode system in a 1-compartment cell. Working electrode and counter electrode are arranged in parallel at a spacing of 40 mm. The reference electrode is located about 2 mm above the working electrode. Deposition is carried out cathodically at the working electrode with moderate stirring at 5° C. and a constant cathodic current density of −56 mA/cm². At a deposition time of 60 minutes, a loading of 2.1 mg is deposited.

The counter electrode consists of an electrochemically coated TiO₂—RuO₂—Ti mesh (4×4 cm²). The reference electrode is Ag/AgCl.

The deposited layer is subsequently converted by thermal treatment into a crystalline oxide. Calcination is carried out at 450° C. in air, with the electrode being heated from room temperature to 450° C. over 1 hour and heat treated at a constant 450° C. for a further 90 minutes.

Analysis by optical emission spectral analysis using inductively coupled plasma (ICP-OES) shows that a RuTi composition containing 18 mol % of Ru is obtained here.Other compositions are obtained by changing the concentration of the Ru content in the electrolyte (see Table 1).

TABLE 1
Coating composition for TiO₂—RuO₂ (determined by ICP-OES)
for various bath compositions:

| Bath concentration | Ru content of | Ti content of |
|---|---|---|
| c(RuCl₃)/mM/l | coating/mol % | coating/mol % |
| 3 | 12 | 88 |
| 6 | 14 | 86 |
| 10 | 16 | 84 |
| 13 | 17 | 83 |
| 15 | 18 | 82 |
| 23 | 21 | 79 |

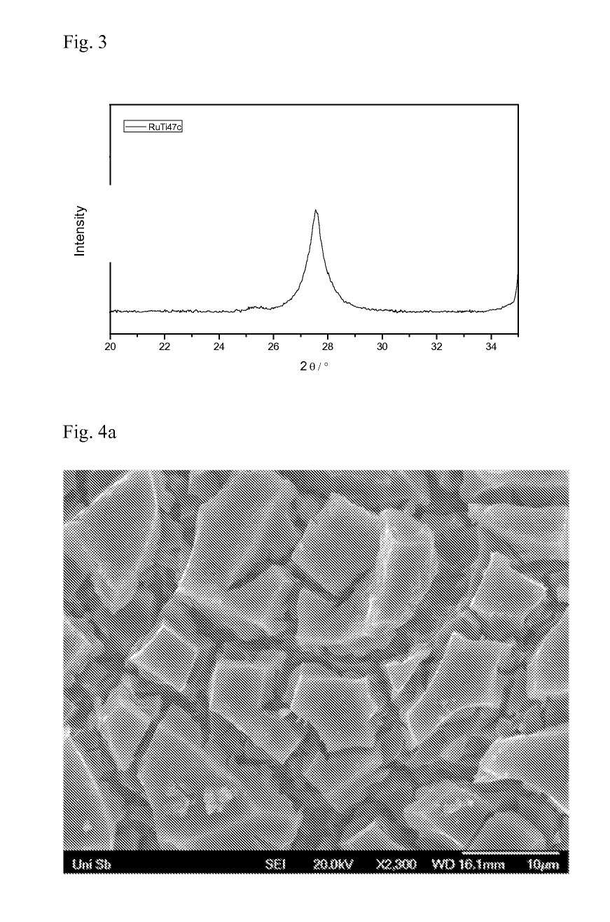

FIG. 3 shows the X-ray diffraction pattern of a TiO₂—RuO₂ mixed oxide containing 18 mol % of Ru. To interpret the TiO₂—RuO₂ mixed oxide formation, the 28 range from 27° to 29° is evaluated. The rutile mixed oxide phase can be seen as the (110) reflection in this range, and is located clearly between the references for the pure TiO₂ rutile phase and the pure RuO₂ rutile phase. The shift in the (110) rutile reflection relative to the references for pure TiO₂ and pure RuO₂ is a clear indication of the formation of a mixed oxide.

Estimation of the crystallite size by the Scherrer method gives crystallite sizes of 18 nm.

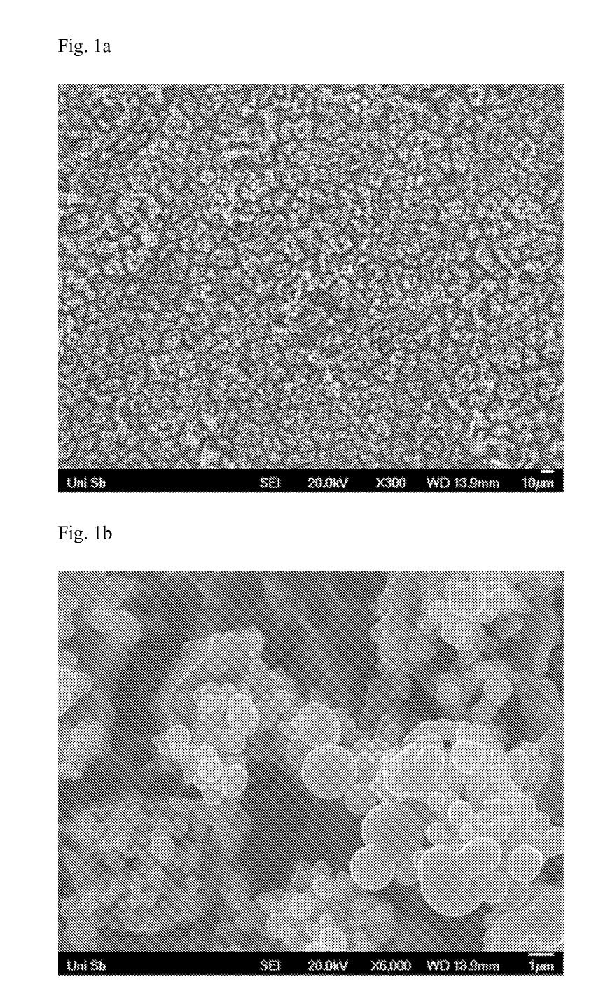

FIGS. 1a and b show the scanning electron micrograph of a TiO₂—RuO₂ mixed oxide containing 18 mol % of Ru. It displays the specific surface structure consisting of mud-cracked surface and spherical structures.

The electrochemical activity for evolution of chlorine was measured on the laboratory scale on titanium electrodes (15 mm diameter, 2 mm thickness) by recording of polarization curves. The interpretation of the data was carried out with the aid of comparative samples which were conventionally prepared by thermal decomposition (see Examples 1c and 1d) or by electrodeposition according to a literature synthesis of Zhitomirsky (see Example 1b). The results are shown in Table 2.

Experimental parameters: measured in 200 g/l of NaCl (pH 3) at a flow of 100 ml/min at 80° C., galvanostatic with 5 minutes per current setting, potential measured against Ag/AgCl and converted to standard hydrogen electrode (SHE), potential values IR-corrected, counter electrode: platinised titanium expanded metal.

TABLE 2
Chlorine potentials for TiO₂—RuO₂

| | | | Composition and | E/V vs. SHE |
|---|---|---|---|---|
| Sample | Preparation | Compound | loading | @ 4 kA/m² |
| See | Thermal | TiO₂—RuO₂/Ti | 31.5 mol % of Ru | 1.423 |
| Example 1c | decomposition | | 16.1 g/m² | |
| | | | noble metal loading | |
| See | Thermal | TiO₂—RuO₂—IrO₂/Ti | 17 mol % of Ru | 1.403 |
| Example 1d | decomposition | | 8.7 mol % of Ir | |
| | | | 10.83 g/m² | |
| | | | noble metal loading | |
| RuTi4 | Electro- | TiO₂—RuO₂/Ti | 18 mol % of Ru | 1.372 |
| | deposition | | Deposition bath | |
| | | | containing 15 mmol/l of | |
| | | | RuCl₃ | |
| | | | Deposition time 60 min | |
| | | | 2.4 g/m² | |
| | | | noble metal loading | |
| RuTi5 | Electro- | TiO₂—RuO₂/Ti | 21 mol % of Ru | 1.382 |
| | deposition | | Deposition bath | |
| | | | containing 23 mmol/l of | |
| | | | RuCl₃ | |
| | | | Deposition time 60 min | |
| | | | 3 g/m² | |
| | | | noble metal loading | |
| Literature | Electro- | TiO₂—RuO₂/Ti | 9 mol % of Ru | 1.462 |
| synthesis by | deposition | | 2.3 g/m² | |
| the method of | | | noble metal loading | |
| Zhitomirsky | | | | |
| (see | | | | |
| Example 1b) | | | | |

Compared to the standard samples prepared conventionally by thermal decomposition (see Example 1c and Example 1d), the electrochemically prepared TiO₂—RuO₂ mixed oxides display a lower chlorine potential and thus a higher catalytic activity at a lower noble metal loading. A comparative sample having the same absolute ruthenium loading was likewise produced by the synthesis of Zhitomirsky via electrodeposition (for production of the comparative sample, see Example 1b). Here too, this process developed here displays a higher catalytic activity and thus an improvement over the prior art.

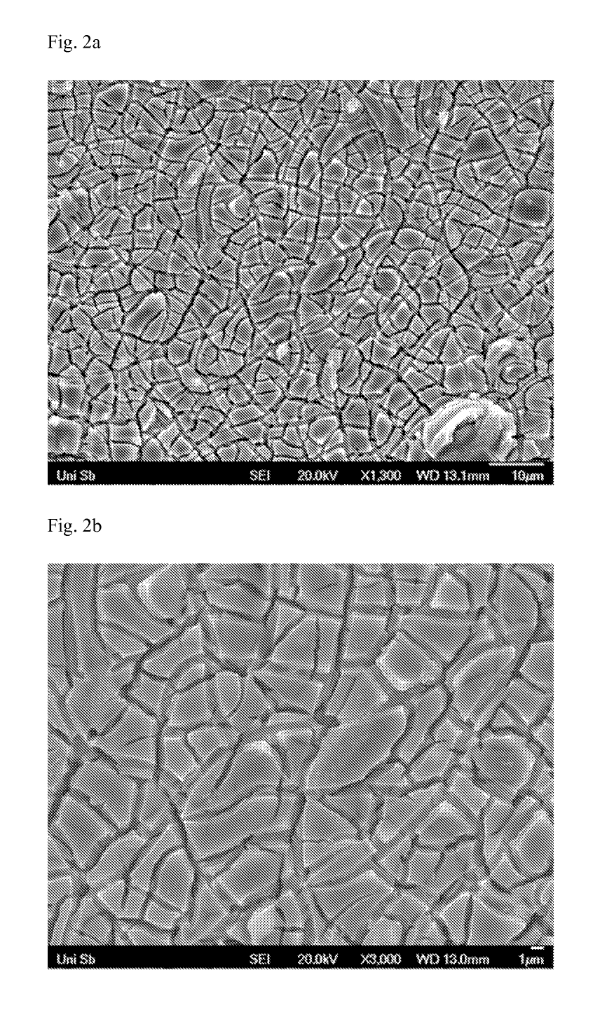

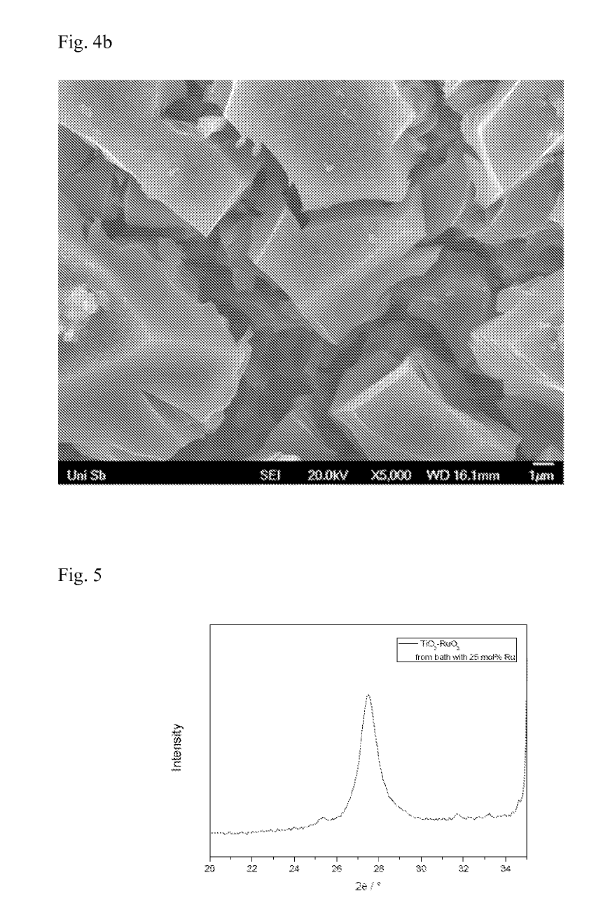

FIGS. 4a+b show scanning electron micrographs of the comparative sample produced by the Zhitomirsky method. The surface morphology of this sample very strongly resembles the conventionally prepared standard sample (from Example 1c, cf. FIGS. 2a+b) and thus displays a significant difference from the samples from the process developed here (cf. FIGS. 1a+b).

### Example 1b

### Example: Reworking of a literature synthesis for TiO₂—RuO₂/Ti coatings

Preparation of a TiO₂—RuO₂ mixed oxide on titanium according to the literature example. In Journal of Materials Science, 1999, 34, pages 2441-2447, I. Zhitomirsky describes for the first time simultaneous electrochemical deposition of TiO₂ and RuO₂, where the two components are deposited as mixed oxides. The same synthesis may also be found in further publications (I. Zhitomirsky, Journal of the European Ceramic Society, 1999, 19, pages 2581-2587 and I. Zhitomirsky, Advances in Colloid and Interface Science, 2002, 97, pages 279-317).

A bath consisting of methanol, water, ruthenium(III) chloride (RuCl₃), titanium(IV) chloride (TiCl₄) and hydrogen peroxide (H₂O₂) is used in this electrosynthesis. At cathodic current densities of −20 mA/cm², TiO₂—RuO₂ layers are successively deposited as multilayer (according to I. Zhitomirsky in Journal of Materials Science, 1999, 34, pages 2441-2447).

The titanium electrode in the form of a plate having a diameter of 15 mm and a thickness of 2 mm is pretreated by sand blasting and chemical pickling (2 hours at 80° C. in 10% strength by weight oxalic acid).

The deposition bath is prepared according to the literature method (I. Zhitomirsky, Journal of Materials Science, 1999, 34, pages 2441-2447) by mixing a titanium stock solution (A) and a ruthenium stock solution (B) at 1° C.

The titanium stock solution (A) contains 5 millimol/litre of titanium(IV) chloride (5 mM/1 of TiCl₄) and 10 millimol/litre of hydrogen peroxide (10 mM/1 of H₂O₂) in methanol.

The ruthenium stock solution (B) contains 5 millimol/litre of ruthenium(III) chloride (5 mM/1 of RuCl₃) in water.

The titanium stock solution (A) and the ruthenium stock solution (B) are mixed in a volume ratio of 3:1.

The electrodeposition is carried out in a 3-electrode system in a 1-compartment cell.

Working electrode and counter electrode are arranged parallel at a spacing of 40 mm. The reference electrode is located about 2 mm above the working electrode. The counter electrode consists of an electrochemically coated TiO₂—RuO₂—Ti mesh (4×4 cm²). Reference electrode is Ag/AgCl.

Deposition is carried out cathodically on the working electrode without stirring at 1° C. and a constant cathodic current density of −20 mA/cm². According to the published method, the coating is deposited successively as multilayer over a deposition time of 10 minutes in each case. Here, a loading of about 0.8 mg is deposited in each case.

The deposited layer is subsequently converted into a crystalline oxide by thermal treatment. The calcination is carried out after each deposition step for 10 minutes at 450° C. in air. After the desired oxide loading has been reached, a final calcination is carried out at 450° C. in air, with the electrode being heated from room temperature to 450° C. over 1 hour and heat treated at a constant 450° C. for a further 90 minutes.

Analysis by optical emission spectral analysis using inductively coupled plasma (ICP-OES) shows that an RuTi composition containing 9 mol % of Ru is obtained here.

Experiments to obtain mixed oxides having an increased RuO₂ content were likewise carried out. For this purpose, the amount of the RuCl₃ salt added was simply increased. The methanol/water ratio was kept constant. The layers obtained were analysed by X-ray diffraction.

The diffraction patterns shown here were all corrected on the 28 axis to the (002) reflection of titanium as internal reference.

Diffraction patterns of layers obtained from baths having different Ru contents at −20 mA/cm² and a deposition time of 20 minutes with subsequent calcination at 450° C. are shown. All deposition baths were freshly made up a few minutes before deposition.

The diffraction pattern of a TiO₂—RuO₂ coating produced by the literature method of Zhitomirsky using a 25% Ru bath composition is shown in FIG. 5. To interpret the TiO₂—RuO₂ mixed oxide formation, the 28 range from 27° to 29° is evaluated. A rutile phase which is located virtually completely on the pure TiO₂ rutile reference is present in this range.

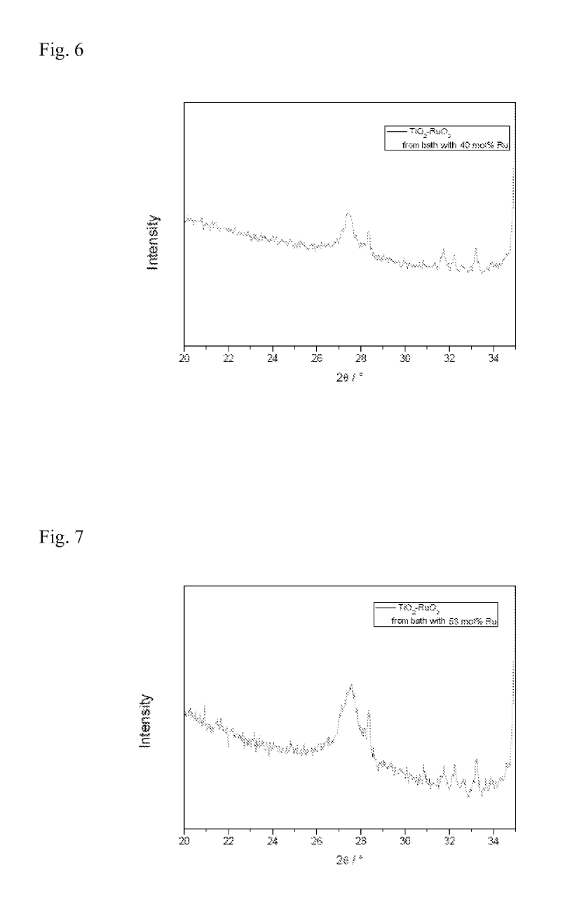

The diffraction pattern of a TiO₂—RuO₂ coating produced by the modified literature method of Zhitomirsky using a 40% Ru bath composition is shown in FIG. 6. In the modified Zhitomirsky synthesis using an increased RuCl₃ content, the deposition rate decreases considerably compared to the unmodified Zhitomirsky synthesis. The layer obtained in the same deposition time corresponds to only ⅕ of the loading obtained from the unmodified synthesis. The diffraction pattern shows a rutile phase which, at 27.48° (±0.08°) is located completely on the pure TiO₂ reference. Enrichment of the rutile phase with RuO₂ is thus not observed here. Furthermore, a number of foreign phases which cannot be assigned are formed.

The diffraction pattern of a TiO₂—RuO₂ coating produced by the modified literature method of Zhitomirsky using a 53% Ru bath composition is shown in FIG. 7. When the RuCl₃ concentration is increased further, the deposition rate is still low. The diffraction pattern shows, at 27.5°, an inhomogeneous rutile peak which obviously represents a superposition of a plurality of rutile phases. Here too, foreign phases which cannot be assigned were formed.

In summary, it can be said on the basis of the diffraction patterns that a further increase in the RuCl₃ content results in a poor deposition rate and poor mixed oxide formation.

### Example 1c

### TiO₂—RuO₂ Mixed Oxide Prepared by Thermal Decomposition

To produce a coating by thermal decomposition, a coating solution containing 2.00 g of ruthenium(III) chloride hydrate (Ru content: 40.5% by weight), 21.56 g of n-butanol, 0.94 g of concentrated hydrochloric acid and 5.93 g of tetrabutyl titanate Ti—(O-Bu)₄) was prepared. Part of the coating solution was applied by means of a brush to a titanium plate which had previously been pickled in 10% strength by weight oxalic acid at about 90° C. for 0.5 hour. This was dried after application of the coating for 10 minutes at 80° C. in air and subsequently treated at 470° C. in air for 10 minutes. This procedure (application of solution, drying, heat treatment) was carried out a total of eight times. The plate was subsequently treated at 520° C. in air for one hour. The ruthenium area loading was determined from the consumption of the coating solution and found to be 16.1 g/m², at a composition of 31.5 mol % of RuO₂ and 68.5 mol % of TiO₂.

### Example 1d

### TiO₂—RuO₂—IrO₂ mixed oxide prepared by thermal decomposition

To produce a coating by thermal decomposition, a coating solution containing 0.99 g of ruthenium(III) chloride hydrate (Ru content: 40.5% by weight), 0.78 g of iridium(III) chloride hydrate (Ir content: 50.9% by weight), 9.83 g of n-butanol, 0.29 g of concentrated hydrochloric acid and 5.9 g of tetrabutyl titanate Ti—(O-Bu)₄) was prepared. Part of the coating solution was applied by means of a brush to a titanium plate which had been pickled beforehand in 10% strength by weight oxalic acid at 90° C. for 0.5 hour. This was dried after application of the coating for 10 minutes at 80° C. in air and subsequently treated at 470° C. in air for 10 minutes. This procedure (application of the solution, drying, heat treatment) was carried out a total of eight times. The plate was subsequently treated at 470° C. in air for one hour. The ruthenium area loading was determined from the weight increase and found to be 5.44 g/m² and the iridium area loading was in a corresponding way found to be 5.38 g/m² (total noble metal loading: 10.83 g/m²), at a composition of 17.0 mol % of RuO_{2, 8.7} mol % of IrO₂ and 74.3 mol % of TiO₂.

### Example 2

### Preparation of a TiO₂—RuO₂—IrO₂ mixed oxide on titanium The pretreatment of the titanium electrode (plate having a diameter of 15 mm and a thickness of 2 mm) was carried out as described in Example 1.

The deposition bath contains isopropanol (i-PrOH) and water in a volume ratio of 9:5, 63 millimol/litre of titanium(IV) chloride (63 mM/1 of TiCl₄), 15 millimol/litre of ruthenium(III) chloride (15 mM/1 of RuCl₃), 5 millimol/litre of iridium(III) chloride (5 mM/1 of IrCl₃), 40 millimol/litre of hydrochloric acid (40 mM/1 of HCl) and 12 millimol/litre of sodium chloride (12 mM/1 of NaCl).

(The alcohol/water ratio indicated in the example is the final ratio which is to be obtained after addition of all salts and acids.)

Electrodeposition was carried out in the same arrangement as described in Example 1 with moderate stirring at 5° C. and a constant cathodic current density of −80 mA/cm² in 2 steps having a deposition time of 50 and 10 minutes. Here, a loading of 1.8 mg is deposited.

A thermal treatment of the deposited layer to effect conversion into a crystalline oxide followed. Between the two deposition steps the samples were heated from RT to 450° C. over a period of 30 minutes and calcined at 450° C. for a further 10 minutes. After the depositions, the samples were calcined once more. The calcination was carried out at 450° C. in air, with the electrode being heated from room temperature to 450° C. over a period of 1 hour and heat treated at a constant 450° C. for a further 90 minutes.

The dependence of the coating composition on the bath composition is shown in Table 3.

TABLE 3
Coating composition for TiO₂—RuO₂—IrO₂ (determined by ICP-OES)
for various bath compositions:

| Bath concentration | Ru content of | Ir content of | Ti content of |
|---|---|---|---|
| c(IrCl₃)/mM/l | coating/mol % | coating/mol % | coating/mol % |
| 2.4 | 17.1 | 1.5 | 81.4 |
| 4.8 | 16 | 2.6 | 81.4 |
| 7.1 | 15.5 | 3.5 | 81 |
| 9.5 | 15 | 4.5 | 80.5 |

The electrochemical activity for chlorine evolution was measured on a laboratory scale on titanium electrodes (15 mm diameter, 2 mm thickness) by recording of polarization curves and compared with standard samples which had been conventionally prepared. The results are shown in Table 4.

Experimental parameters: measured in 200 g/l of NaCl (pH 3) at a flow of 100 ml/min at 80° C., galvanostatic with 5 minutes per current setting, potential measured against Ag/AgCl and converted to standard hydrogen electrode (SHE), potential values IR-corrected, counter electrode: platinised titanium expanded metal.

The electrochemically prepared TiO₂—RuO₂—IrO₂ mixed oxides display a lower chlorine potential and thus a higher catalytic activity compared to the standard samples at a lower noble metal loading.

TABLE 4
Chlorine potentials for TiO₂—RuO₂—IrO₂

| | | | | E/V vs. SHE |
|---|---|---|---|---|
| Sample | Preparation | Compound | Composition and loading | @ 4 kA/m² |
| See | Thermal | TiO₂—RuO₂/Ti | 31.5 mol % of Ru | 1.423 |
| Example 1c | decomposition | | 16.1 g/m² | |
| | | | noble metal loading | |
| See | Thermal | TiO₂—RuO₂—IrO₂/Ti | 17 mol % of Ru | 1.403 |
| Example 1d | decomposition | | 8.7 mol % of Ir | |
| | | | 10.83 g/m² | |
| | | | noble metal loading | |
| IrRuTi3 | Electro- | TiO₂—RuO₂—IrO₂/Ti | 15.5 mol % of Ru | 1.408 |
| | deposition | | 3.5 mol % of Ir | |
| | | | Deposition bath containing | |
| | | | 7.1 mmol/l of IrCl₃ | |
| | | | Deposition time 50 min | |
| | | | 2.1 g/m² | |
| | | | noble metal loading | |
| IrRuTi4 | Electro- | TiO₂—RuO₂—IrO₂/Ti | 15 mol % of Ru | 1.390 |
| | deposition | | 4.5 mol % of Ir | |
| | | | Deposition bath containing | |
| | | | 9.5 mmol/l of IrCl₃ | |
| | | | Deposition time 50 min | |
| | | | 3 g/m² | |
| | | | noble metal loading | |

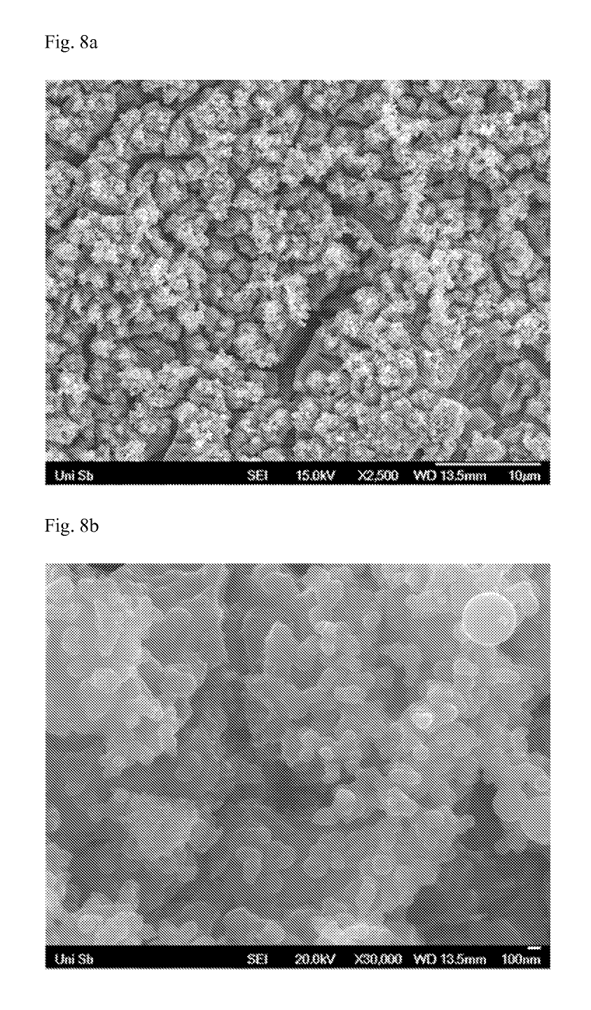

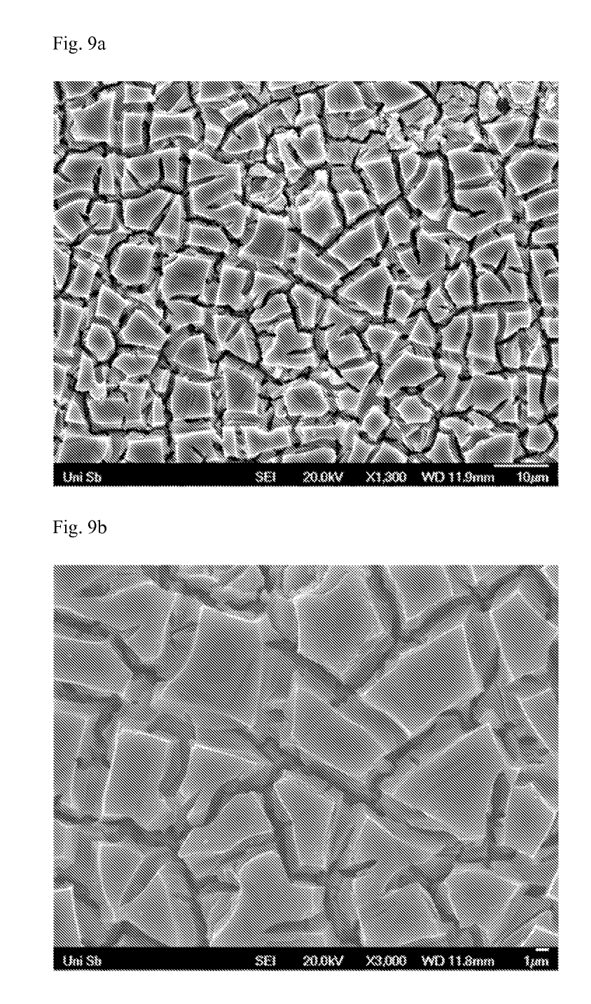

The surface morphology of an electrochemically prepared TiO₂—RuO₂—IrO₂ sample is shown as scanning electron micrograph in FIGS. 8a+b. Here too, as in Example 1a (FIGS. 1a, b), the mud-cracked surface in combination with the spherical structures can be seen. A conventionally prepared TiO₂—RuO₂—IrO₂ standard sample (see Example 1d) does not display these spherical structures (FIGS. 9a+b).

### Example 3

### Preparation of a TiO₂—RuO₂—SnO₂ mixed oxide on titanium

The pretreatment of the titanium electrode (plate having a diameter of 15 mm and a thickness of 2 mm) was carried out as described in Example 1.

The deposition bath contains isopropanol (i-PrOH) and water in a volume ratio of 9:5, 63 millimol/litre of titanium(IV) chloride (63 mM/1 of TiCl₄), 15 millimol/litre of ruthenium(III) chloride (15 mM/1 of RuCl₃), 3.7 millimol/litre of tin(IV) chloride (3.7 mM/1 of SnCl₃), 20 millimol/litre of hydrochloric acid (20 mM/1 of HCl) and 12 millimol/litre of sodium chloride (12 mM/1 of NaCl).

(The alcohol/water ratio indicated in the example is the final ratio which is to be obtained after addition of all salts and acids.)

Electrodeposition was carried out in the same arrangement as described in Example 1 with moderate stirring at 5° C. and a constant cathodic current density of −56 mA/cm² in 2 steps having a deposition time of 60 and 20 minutes. Here, a loading of 2.1 mg is deposited.

The thermal treatment of the deposited layer to effect conversion into a crystalline oxide was carried out as in Example 2. The dependence of the coating composition on the bath composition is shown in Table 5.

TABLE 5
Coating composition for TiO₂—RuO₂—SnO₂ (determined by ICP-OES)
for various bath compositions:

| Bath concentration | Ru content of | Sn content of | Ti content of |
|---|---|---|---|
| c(SnCl₄)/mM/l | coating/mol % | coating/mol % | coating/mol % |
| 3.7 | 16.5 | 6.6 | 77 |
| 7.3 | 14.6 | 11 | 74.4 |

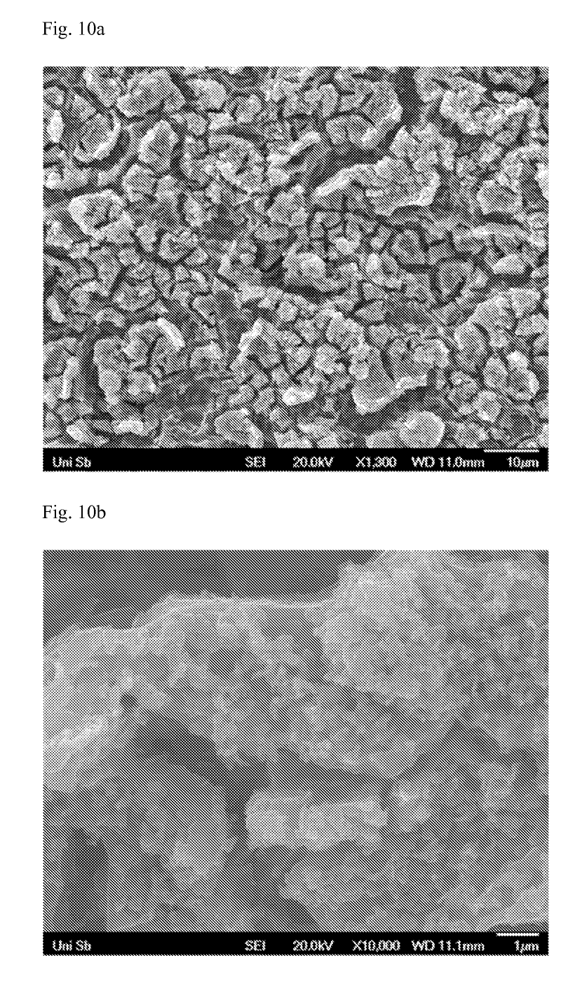

The surface morphology of an electrochemically prepared TiO₂—RuO₂—SnO₂ sample is shown as scanning electron micrograph in FIGS. 10a+b. Here too, as in Example 1a (FIGS. 1a, b) the mud-cracked surface in combination with the spherical structures can be seen.

### Example 4

### Preparation of a TiO₂—RuO₂—SbO₂ mixed oxide on titanium

The pretreatment of the titanium electrode (plate having a diameter of 15 mm and a thickness of 2 mm) was carried out as described in Example 1.

The deposition bath contains isopropanol (i-PrOH) and water in a volume ratio of 9:1, 56 millimol/litre of titanium(IV) chloride (56 mM/1 of TiCl₄), 13 millimol/litre of ruthenium(III) chloride (13 mM/1 of RuCl₃), 3.7 millimol/litre of antimony(III) chloride (3.7 mM/1 of SbCl₃), 20 millimol/litre of hydrochloric acid (20 mM/1 of HCl) and 11 millimol/litre of sodium chloride (11 mM/1 of NaCl).

(The alcohol/water ratio indicated in the example is the final ratio which is to be obtained after addition of all salts and acids.)

Electrodeposition was carried out in the same arrangement as described in Example 1 with moderate stirring at 5° C. and a constant cathodic current density of −28 mA/cm² in two steps having a deposition time of 30 and 20 minutes. Here, a loading of 1.8 mg is deposited.

The thermal treatment of the deposited layer to effect conversion into a crystalline oxide was carried out as in Example 2. The dependence of the coating composition on the bath composition is shown in Table 6.

TABLE 6
Coating composition for TiO₂—RuO₂—SbO₂ (determined by ICP-OES)
for various bath compositions:

| Bath concentration | Ru content of | Sb content of | Ti content of |
|---|---|---|---|
| c(SbCl₃)/mM/l | coating/mol % | coating/mol % | coating/mol % |
| 1.9 | 15.5 | 2.1 | 82.4 |
| 3.7 | 14.3 | 4.1 | 81.6 |
| 4.8 | 14.3 | 5 | 80.7 |
| 6 | 13.9 | 6.2 | 79.9 |
| 7.1 | 14.4 | 7.5 | 78.1 |

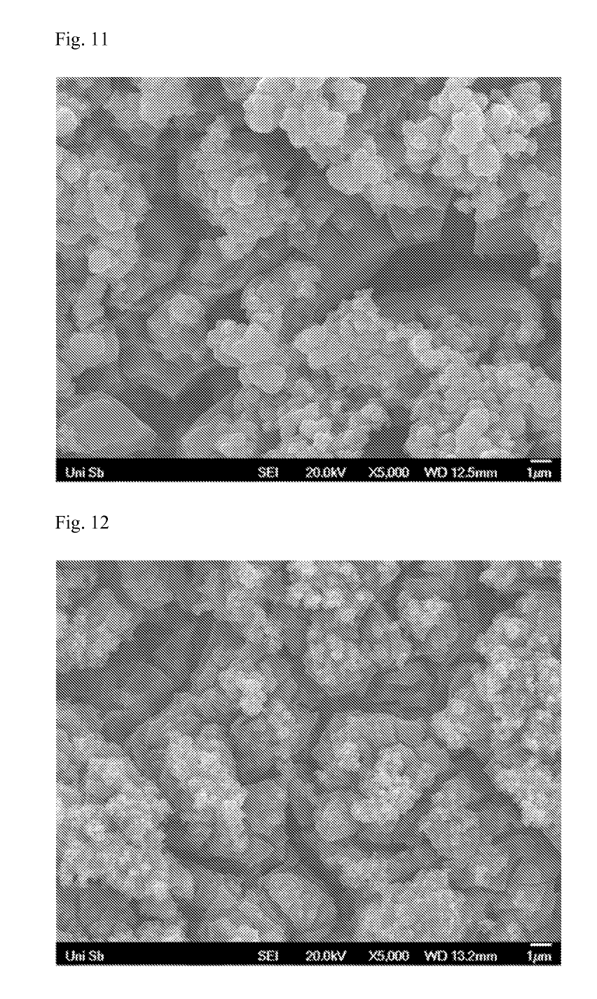

The surface morphology of an electrochemically prepared TiO₂—RuO₂—SnO₂ sample is shown as scanning electron micrograph in FIG. 11. Here too, as in Example 1a (FIGS. 1a, b) the mud-cracked surface in combination with the spherical structures can be seen.

### Example 5

### Preparation of a TiO₂—RuO₂—MnO₂ mixed oxide on titanium

The pretreatment of the titanium electrode (plate having a diameter of 15 mm and a thickness of 2 mm) was carried out as described in Example 1.

The deposition bath contains isopropanol (i-PrOH) and water in a volume ratio of 9:5, 63 millimol/litre of titanium(IV) chloride (63 mM/1 of TiCl₄), 15 millimol/litre of ruthenium(III) chloride (15 mM/1 of RuCl₃), 3 millimol/litre of manganese(II) chloride (3 mM/1 of MnCl₂), 20 millimol/litre of hydrochloric acid (20 mM/1 of HCl) and 12 millimol/litre of sodium chloride (12 mM/1 of NaCl).

(The alcohol/water ratio indicated in the example is the final ratio which is to be obtained after addition of all salts and acids.)

Electrodeposition was carried out in the same arrangement as described in Example 1 with moderate stirring at 5° C. and a constant cathodic current density of −80 mA/cm⁻² in two steps having a deposition time of 40 and 10 minutes. Here, a loading of 3.8 mg is deposited.

The thermal treatment of the deposited layer to effect conversion into a crystalline oxide was carried out as in Example 2. The dependence of the coating composition on the bath composition is shown in Table 7.

TABLE 7
Coating composition for TiO₂—RuO₂—MnO₂ (determined by ICP-OES)
for various bath compositions:

| Bath concentration | Ru content of | Mn content of | Ti content of |
|---|---|---|---|
| c(MnCl₂)/mM/l | coating/mol % | coating/mol % | coating/mol % |
| 2.9 | 17.1 | 3 | 79.9 |
| 8.7 | 15.4 | 6 | 78.6 |
| 14.4 | 13.1 | 11.6 | 75.2 |

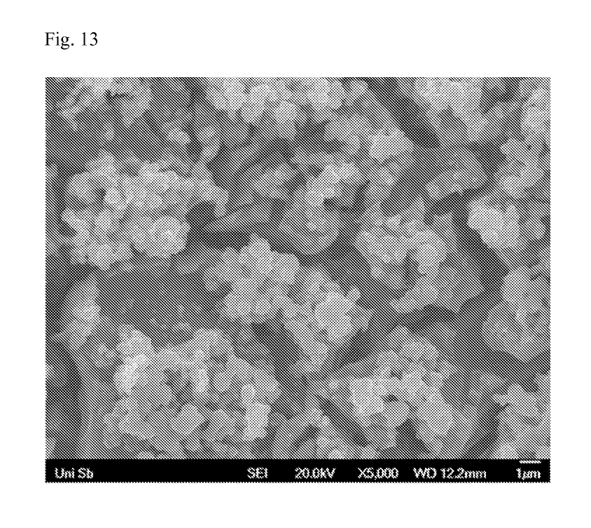

The surface morphology of an electrochemically prepared TiO₂—RuO₂—MnO₂ sample is shown as scanning electron micrograph in FIG. 12. Here too, as in Example 1a (FIG. 1) the mud-cracked surface in combination with the spherical structures can be seen.

### Example 6

### Preparation of a quaternary TiO₂—RuO₂—SnO₂—SbO₂ mixed oxide on titanium

The pretreatment of the titanium electrode (plate having a diameter of 15 mm and a thickness of 2 mm) was carried out as described in Example 1.

The deposition bath contains isopropanol (i-PrOH) and water in a volume ratio of 9:1, 56 millimol/litre of titanium(IV) chloride (56 mM/1 of TiCl₄), 13 millimol/litre of ruthenium(III) chloride (13 mM/1 of RuCl₃), 2 millimol/litre of antimony(III) chloride (2 mM/1 of SbCl₃), 6.6 millimol/litre of tin(IV) chloride (6.6 mM/1 of SnCl₄), 20 millimol/litre of hydrochloric acid (20 mM/1 of HCl) and 11 millimol/litre of sodium chloride (11 mM/1 of NaCl).

(The alcohol/water ratio indicated in the example is the final ratio which is to be obtained after addition of all salts and acids.)

Electrodeposition was carried out in the same arrangement as described in Example 1 with moderate stirring at 5° C. and a constant cathodic current density of −29 mA/cm² in two steps having a deposition time of 20 minutes each. Here, a loading of 1.7 mg is deposited.

The thermal treatment of the deposited layer to effect conversion into a crystalline oxide was carried out as in Example 2. The dependence of the coating composition on the bath composition is shown in Table 8.

TABLE 8
Coating composition for TiO₂—RuO₂—SnO₂—SbO₂ (determined by ICP-OES)
for various bath compositions:

| Bath composition | Ru content of | Sb content of | Sn content of | Ti content of |
|---|---|---|---|---|
| c(SnCl₄)/mM/l | coating/mol % | coating/mol % | coating/mol % | coating/mol % |
| 3.3 | 14.2 | 2.7 | 3.8 | 79.4 |
| 6.6 | 12.7 | 1.8 | 9.4 | 76.1 |
| 9.8 | 11.6 | 1.6 | 14.4 | 72.4 |
| 13.1 | 11 | 1.5 | 17.8 | 69.7 |
| 16.4 | 9.8 | 1.5 | 20.6 | 68.1 |

The surface morphology of an electrochemically prepared TiO₂—RuO₂—SnO₂ sample is shown as scanning electron micrograph in FIG. 13. Here too, as in Example 1a (FIG. 1) the mud-cracked surface in combination with the spherical structures can be seen.

1. Catalyst coating comprising electrocatalytically active components based on ruthenium oxide and titanium oxide and optionally one or more metallic doping elements, wherein said ruthenium oxide and titanium oxide are predominantly present as RuO₂ and TiO₂ in rutile form, wherein said RuO₂ and TiO₂ are predominantly present as mixed oxide phase.

2. The catalyst coating of claim 1, wherein the one of more metallic doping elements are selected from the group consisting of iridium, tin, antimony, and manganese.

3. The catalyst coating of claim 1, wherein the ruthenium is present in an amount of from 10 to 21 mol %, based on the total amount of metals in the catalytically active component.

4. The catalyst coating of claim 1, wherein at least 75% by weight of the RuO₂ and TiO₂ is present as mixed oxide phase.

5. A process for electrochemically producing a catalyst coating comprising electrocatalytically active components based on ruthenium oxide and titanium oxide and optionally one or more metallic doping elements, comprising the step of applying the catalyst coating in a layer to an electrically conductive support material, wherein
a) the layer is applied to the support by means of an electrochemical process via the precipitation of Ru and Ti from an acidic aqueous solution containing at least Ru salts and titanium salts as hydroxo precursors, with the support being connected as cathode, and
b) the formed layer comprising hydroxo compounds and is subsequently subjected to thermal treatment at a temperature of at least 300° C. to form the catalyst coating.

6. The process of claim 5, wherein the support is based on metallic titanium or tantalum.

7. The process of claim 5, wherein the salt solution in step a) has a pH of not more than 3.5.

8. The process of claim 5, wherein the salt solution in step a) is kept acidic by means of dilute hydrochloric acid.

9. The process of claim 5, wherein a mixture of water with a lower alcohol is used as solvent for the salt solution in step a).

10. The process of claim 5, wherein a current density (absolute value) of at least 30 mA/cm² is maintained during the deposition in step a).

11. The process of claim 5, wherein the salt solution in step a) is maintained at a temperature of not more than 20° C.

12. The process of claim 5, wherein the precipitation of the hydroxo precursors of the metal oxides is effected by local base formation at the electrode surface.

13. The process of claim 5, wherein the heat treatment in step b) is carried out for at least 10 minutes.

14. An electrode comprising the catalyst coating of claim 1.

15. The catalyst coating of claim 1, wherein said mixed oxide phase is recognizable by a shift in the X-ray diffraction reflection at 27.477° (2 theta value of the pure TiO₂ rutile phase in the Cu Kₐₗₚₕₐ diffraction spectrum) to an angle of at least 27.54°.

16. The catalyst coating of claim 2, wherein the one of more metallic doping elements is iridium.

17. The catalyst coating of claim 2, wherein the one of more metallic doping elements is present in an amount of up to 20 mol %.
